(19) United States
(12) Patent Application Publication
(10) Pub. No.: US 2005/0003975 A1
(43) Pub. Date: Jan. 6, 2005

(54) Blooming soap bars

(76) Inventors: Yvonne Bridget Browne, Bagshot (GB); Lynette Anne Makins Holland, Watford (GB); Zerlina Guzdar Dubois, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/864,184

(22) Filed: Jun. 9, 2004

Related U.S. Application Data
(60) Provisional application No. 60/479,298, filed on Jun. 18, 2003.

(51) Int. Cl. C11D 3/50

(52) U.S. Cl. 510/101

(57) ABSTRACT

Perfume compositions comprising defined high impact accords and personal cleansing compositions, especially soap bars, comprising those perfume compositions are provided. In a preferred aspect, the perfume compositions are encapsulated in starch or the like so as to release fragrance when exposed to water, such as in the shower.

### CROSS REFERENCE TO RELATED APPLIATION

This application claims the benefit of U.S. Provisional Application No. 60/479298, filed Jun. 18, 2003.

### FIELD

The present invention relates to perfume compositions and to personal cleansing compositions, especially soap bars, comprising those perfume compositions.

### BACKGROUND

Fragrances such as perfumes are often added directly to personal cleansing compositions, such as bar soaps. There are, however, several disadvantages when perfumes are mixed as neat oil into the products. One problem is that some perfume ingredients are not stable in the soap matrix and thus are subject to damage and/or loss. They can also undergo an oxidative or other chemical reaction (e.g., by oxygen, light, heat etc.) and cause undesired discoloration of the products containing them.

A further disadvantage arising from the direct addition of perfumes to base soap compositions is that perfume components are, in general, volatile and, therefore, easily lost from the product during processing or storage. The loss of the highly volatile fraction of the perfume is especially high. As a result, in the past, personal cleansing bars tended to employ perfumes composed mainly of less volatile perfume components to maximise survival of the fragrance during processing and storage of the bar and thus provide better in-use and after-use fragrance benefits. This was not the most desirable situation, however, because some of the volatile, low boiling perfume ingredients can provide a fresh and clean impression, and it is highly desirable that these ingredients be present in the personal cleansing product. It is also these high volatility materials that provide fragrance bloom during showering. Therefore, removing these from perfume compositions worsens the fragrance profile from current personal cleansing products, such as bar soaps.

Another problem arising from the direct addition of perfume to base compositions is that there is no flexibility to simultaneously optimize fragrance display in the neat product (e.g., the bar) and during use of the product. For example, the optimum fragrance level during use may result in the neat product smelling too strongly. Likewise, the optimum fragrance level in the neat product may lead to less satisfactory results during use. It would be desirable to be able to adjust the fragrance display independently in the neat product and in use.

Perfumes are commonly added to personal cleansing compositions to impart aesthetically attractive aromas. Perfumes can be designed and selected to make a variety of impressions on the user. Unfortunately, any particular perfume will typically convey only a single or continuous overall message, and would not clearly communicate the multiple functions of a multi-function cleansing product or be enhanced during the products' usage to reinforce the performance of the product. Therefore, it is highly desirable that dual fragrance characters be delivered to convey the distinctiveness of the product or multiple, distinct functions of the product. In particular, it is desirable in a personal cleansing product not only that it have a generally pleasant fragrance, but that it also “bloom” when wetted to provide the fresh and clean impression desired by consumers.

Others have attempted to provide improved fragrance delivery. For example, U.S. Pat. No. 5,336,665 to Garner-Gray et al. issued Aug. 9, 1994 discloses fragrance complexes using a hydrophobic inorganic carrier for deposition. However, these carriers are not designed to release a significant perfume bloom during the washing process.

EP 0 902 679 discloses fragrance complexes using hydrophilic inorganic carriers in a bar soap, in combination with dual fragrances, but does not disclose the selection of materials to deliver enhanced fragrance bloom.

EP 0 965 326 discloses the use of selected fragrance materials in combination with fragrance carriers. However, this invention focuses on delivering long lasting odour benefits to laundry, especially to dry fabrics.

### SUMMARY

According to a first aspect of the invention, a perfume composition is provided comprising:
a) at least 10% by weight of at least one High Impact Accord (“HIA”) perfume ingredient of Class 1, wherein Class 1 perfume ingredients have (1) a boiling point at 760 mm Hg, of 275° C. or lower, (2) a calculated CLogP of at least 2.0, and (3) an odor detection threshold (“ODT”) less than or equal to 50 ppb; and
b) from 0.01 to less than 30% by weight of at least one High Impact Accord (“HIA”) perfume ingredient of Class 2, wherein Class 2 perfume ingredients have (1) a boiling point at 760 mm Hg, of greater than 275° C., (2) a calculated CLogP of at least 4.0, and (3) an odor detection threshold (“ODT”) less than or equal to 50 ppb.

The high impact, due partly to the low odor detection threshold, of the present perfumes means that they do not suffer from the problems associated with prior art fragrances.

According to a preferred embodiment, the perfume composition is present in an encapsulated form. According to a second aspect of the invention, personal cleansing compositions comprising the perfume compositions according to the first aspect, especially bar soaps, are provided.

These and other features, aspects, and advantages of the present invention will become evident to those skilled in the art from a reading of the present disclosure.

### DETAILED DESCRIPTION

All cited references are incorporated herein by reference in their entireties. In addition, all percentages are by weight of total composition unless specifically stated otherwise and all ratios are weight ratios unless specifically stated otherwise.

Except where specific examples of actual measured values are presented, numerical values referred to herein should be considered to be qualified by the word “about”.

The perfume composition according to the first aspect of the invention comprises at least two classes of perfume ingredients: a first High Impact Accord (“HIA”) perfume ingredient, the first perfume ingredient having (1) a boiling point at 760 mm Hg, of 275° C. or lower, (2) a calculated CLogP of at least 2.0, and (3) an odor detection threshold (“ODT”) less-than or equal to 50 ppb, and a second High Impact Accord (“HIA”) perfume ingredient, the second perfume ingredient having (1) a boiling point at 760 mm Hg, of greater than 275° C., (2) a calculated CLogP of at least 4.0, and (3) an odor detection threshold (“ODT”) less than or equal to 50 ppb.

The HIA perfume ingredients are characterized by their respective boiling point (B.P.), octanol/water partition coefficient (P) and odor detection threshold (“ODT”).

The octanol/water partition coefficient of a perfume ingredient is the ratio between its equilibrium concentrations in octanol and in water.

The boiling points of many perfume ingredients, at standard pressure (760 mm Hg) are given in, e.g., “Perfume and Flavor Chemicals (Aroma Chemicals),” Steffen Arctander, published by the author.

The logP values of many perfume ingredients have been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present invention.

Odor detection thresholds are determined using a gas chromatograph. The gas chromatograph is calibrated to determine the exact volume of material injected by the syringe, the precise split ratio, and the hydrocarbon response using a hydrocarbon standard of known concentration and chain-length distribution. The air flow rate is accurately measured and, assuming the duration of a human inhalation to last 12 seconds, the sampled volume is calculated. Since the precise concentration at the detector at any point in time is known, the mass per volume inhaled is known and hence the concentration of material. To determine whether a material has a threshold below 50 ppb, solutions are delivered to the sniff port at the back-calculated concentration. A panelist sniffs the GC effluent and identifies the retention time when odor is noticed. The average across all panelists determines the threshold of noticeability.

The necessary amount of analyte is injected onto the column to achieve a 50 ppb concentration at the detector. Typical gas chromatograph parameters for determining odor detection thresholds are listed below.
GC: 5890 Series II with FID detector
7673 Autosampler
Column: J & W Scientific DB-1
Length 30 meters ID 0.25 mm film thickness 1 micron
Method:
Split Injection: 17/1 split ratio
Autosampler: 1.13 microliters per injection
Column Flow: 1.10 mL/minute
Air Flow: 345 mL/minute
Inlet Temp. 245 DEG C
Detector Temp. 285° C.
Temperature Information
Initial Temperature: 50° C.
Rate: 5C/minute
Final Temperature: 280° C.
Final Time: 6 minutes
Leading assumptions:
(i) 12 seconds per sniff
(ii) GC air adds to sample dilution

For the first class of perfume ingredients, each Class 1 HIA perfume ingredient of this invention has a B.P., determined at the normal, standard pressure of 760 mm Hg, of 275° C. or lower and an ODT of less than or equal to 50 parts per billion (ppb). Since the partition coefficients of the perfume ingredients of this invention have high values, they are more conveniently given in the form of their logarithm to the base 10, logP, the perfume ingredients of this invention having ClogP of 2 and higher.

Table 1 gives some non-limiting examples of HIA perfume ingredients of Class 1.

TABLE 1
HIA Perfume Ingredients of Class 1
HIA Ingredients of Class 1

Ionone beta
4-(2,2,6-Trimethylcyclohex-1-enyl)-2-but-en-4-one
2,4-Decadienoic acid, ethyl ester (E,Z)-
6-(and -8) isopropylquinoline
Acetaldehyde phenylethyl propyl acetal
Acetic acid, (2-methylbutoxy)-, 2-propenyl ester
Acetic acid, (3-methylbutoxy)-, 2-propenyl ester
Benzaldehyde
2,6,10-Trimethyl-9-undecenal
Glycolic acid, 2-pentyloxy-, allyl ester
Hexanoic acid, 2-propenyl ester
1-Octen-3-ol
trans-Anethole
iso butyl (z)-2-methyl-2-butenoate
Anisaldehyde diethyl acetal
Benzenepropanal, 4-(1,1-dimethylethyl)-
2,6-Nonadien-1-ol
3-methyl-5-propyl-cyclohexen-1-one
Buranoic acid, 2-methyl-, 3-hexenyl ester, (Z)-
Acetaldehyde, [(3,7-dimethyl-6-octenyl)oxy]-
Lauronitrile
2,4-dimethyl-3-cyclohexene-1-carbaldehyde
2-Buten-1-one, 1-(2,6,6-trimethyl-1,3-cyclohexadien-1-yl)-
2-Buten-1-one, 1-(2,6,6-trimethyl-2-cyclohexen-1-yl)-, (E)-
Ethyl-2-Methyl Butyrate
gamma-Decalactone
trans-4-decenal
decanal
2-Pentylcyclopentanone
1-(2,6,6, Trimethyl 3 Cyclohexen-1-yl)-2 Buten-1-one)
2,6-dimethylheptan-2-ol
Benzene, 1,1′-oxybis-
4-Penten-1-one, 1-(5,5-dimethyl-1-cyclohexen-1-yl)-
Butanoic acid, 2-methyl-, ethyl ester
Ethyl anthranilate
2-Oxabicyclo[2.2.2]octane, 1,3,3-trimethyl-
2-6-nonadienal
Eugenol
Citralva Plus
Damarose Alpha
3-(3-isopropylphenyl)butanal
methyl 2-octynoate
Decyl Aldehyde
Methyl-2-nonenoate
4-(2,6,6-trimethyl-1-cyclohexen-1-yl)-3-buten-2-one
Pyrazine, 2-methoxy-3-(2-methylpropyl)-
Quinoline, 6-secondary buty
Isoeugenol
Mandarin Aldehyde
Oxane
2H-Pyran-2-one,tetrahydro-6-(3-pentenyl)-
Cis-3-Hexenyl Methyl Carbonate
Linalool
1,6,10-Dodecatriene, 7,11-dimethyl-3-methylebe-, (E)-
2,6-dimethyl-5-heptenal
4,7 Methanoindan 1-carboxaldehyde, hexahydro
2-methylundecanal
Methyl 2-nonynonate
1,1-dimethoxy-2,2,5-trimethyl-4-hexene
melonal
Methyl Nonyl Acetaldehyde
Undecalactone
Trans-2-Hexanal
Pino Acetaldehyde
Neobutenone
Benzoic acid, 2-hydroxy-, methyl ester
4-Penten-1-one, 1-(5,5-dimethyl-1-cyclohexen-1-yl)
2H-Pyran, 3,6-dihydro-4 methyl-2-(2-methyl-1-propenyl)-
2,6-Octadienenitrile, 3,7-dimethyl-, (Z)-
2,6-nonadienal
6-Nonenal, (Z)-
nonanal
octanal
2-Nonenenitrile
Acetic acid, 4-methylphenyl ester
Gamma Undecalactone
2-norpinene-2-propionaldehyde 6,6 dimethyl
4-nonanolide
9-decen-1-ol
2H-Pyran, tetrahydro-4-methyl-2-(2-methyl-1-propenyl)-
5-methyl-3-heptanone oxime
Octanal, 3,7-dimethyl-
4-methyl-3-decen-5-ol
10-Undecen-1-al
Pyridine, 2-(1-theylpropyl)-
Spiro[furan-2(3H),5′[4,7]methanol[5H]indene], decahydro-
Anisic Aldehyde
Flor Acetate
Rose Oxide
Cis 3 Hexenyl Salicylate
Methyl Octin Carbonate
Ethyl-2-Methyl Butyrate

Of course, the perfume composition of the invention may comprise one or more HIA perfume ingredients of Class 1.

The first class of HIA perfume ingredient is very effusive and very noticeable when the product is in use. Of the perfume ingredients in a given perfume composition, at least 10%, preferably from 15 to 75%, more preferably from 15 to 50% are HIA perfume ingredients of Class 1.

For the second class of perfume ingredients, each Class 2 HIA perfume ingredient of this invention has a B.P., determined at the normal, standard pressure of about 760 mm Hg, of greater than 275° C. and an ODT of less than or equal to 50 parts per billion (ppb). Since the partition coefficients of the perfume ingredients of this invention have high values, they are more conveniently given in the form of their logarithm to the base 10, logP, the perfume ingredients of this invention having ClogP of at least 4.

Table 2 gives some non-limiting examples of HIA perfume ingredients of Class 2.

TABLE 2
HIA Perfume Ingredients of Class 2

Naphthol(2,1-B)-furan,3A-Ethyl Dodecahydro-6,6,9A-Trimethyl
Natural Sinensal
Para Hydroxy phenyl Butanone
2-(Cyclododecyl)-propan-1-ol
Oxacycloheptadecan-2-one
Ketone,Methyl-2,6,10-Trimethyl-2,5,9-Cyclododecatriene-1-yl
8alpha,12oxido-13,14,15,16-tetranorlabdane
Cyclohexane Propanol 2,2,6 Trimethyl-Alpha,Propyl
6,7-Dihydro-1,1,2,3,3-Pentamethyl-4(5H)-Indanone
8-Cyclohexadecan-1-one
2-(2-(4Methyl-3-cyclohexan-1-yl)-cyclopentanone
Oxacyclohexadecen-2-one
3-Methyl-4(5)-Cyclopentadecenone
3-Methyl-5-(2,2,3-trimethyl-3-cyclopenten-1-yl)-4-penten-2-ol
2,4,-Dimethyl-2-(1,1,44,-tetramethyl)tetralin-6-yl)-1,3-dioxolane
Tridecene-2-nitrile
7,Acetyl,1,2,3,4,5,6,7,8-Octahydro-1,1,6,7-Tetra Methyl Naphthalene
5-Cyclohexadecenone-1

Of course, the perfume composition of the invention may comprise one or more HIA perfume ingredients of Class 2.

The second class of HIA perfume ingredient leaves a lingering scent on the skin. Of the perfume ingredients in a given perfume composition, from 0.01 to less than 30% and preferably from 0.01 to 25% are HIA perfume ingredients of Class 2.

Perfume compositions according to the first aspect of the invention may also comprises optional conventional perfume composition materials such as other perfume ingredients not falling within either Class 1 or Class 2, or odourless solvents or oxidation inhibitors, or mixtures thereof. Perfume compositions according to the first aspect of the invention preferably comprise up to 75% of Class 1 and Class 2 HIA perfume ingredients.

In a preferred embodiment of the first aspect of the invention, the perfume composition is encapsulated. A wide variety of encapsulating materials exist which allow for delivery of perfume effect at various times in the cleaning or conditioning process.

Suitable encapsulating materials according to the present invention include starches, oligosaccharides, cyclodextrins, polyethylenes, polyamides, polystyrenes, polyisoprenes, polycarbonates, polyesters, polyacrylates, vinyl polymers polyurethanes, amorphous silica, precipitated silica, fumed silica, aluminosilicates, such as zeolites and alumina, and mixtures thereof. In the event that the encapsulating material comprises amorphous silica, precipitated silica, fumed silica or aluminosilicates such as zeolite and alumina, the pore volume is at least 0.1 ml/g and comprises pores with a diameter between 0.4-10 nm (4 and 100 A). Preferably, amorphous silica gel is used because of its high oil absorbency.

Starches suitable for encapsulating the perfume oils of the present invention include amylose, amylopectin and mixtures thereof. Thje starches may be made from, raw starch, pregelatinized starch, modified starch derived from tubers, legumes, cereal and grains, for example corn starch, wheat starch, rice starch, waxy corn starch, oat starch, cassava starch, waxy barley, waxy rice starch, sweet rice starch, amioca, potato starch, tapioca starch, oat starch, cassava starch, and mixtures thereof.

Modified starches suitable for use as the encapsulating matrix in the present invention include, hydrolyzed starch, acid thinned starch, starch esters of long chain hydrocarbons, starch acetates, starch octenyl succinate, and mixtures thereof.

As used herein, the term “hydrolyzed starch” refers to oligosaccharide-type materials that are typically obtained by acid and/or enzymatic hydrolysis of starches, preferably corn starch. Suitable hydrolyzed starches for inclusion in the present invention include maltodextrins and corn syrup solids. The hydrolyzed starches for inclusion with the mixture of starch esters have a Dextrose Equivalent (DE) values of from about 10 to about 36 DE. The DE value is a measure of the reducing equivalence of the hydrolyzed starch referenced to dextrose and expressed as a percent (on a dry basis). The higher the DE value, the more reducing sugars present. A method for determining DE values can be found in Standard Analytical Methods of the Member Companies of Corn Industries Research Foundation, 6th ed. Corn Refineries Association, Inc. Washington, D.C. 1980, D-52.

Starch esters having a degree of substitution in the range of from about 0.01% to about 10.0% may be used to encapsulate the perfume oils of the present invention. The hydrocarbon part of the modifying ester should be from a C5 to C16 carbon chain. Preferably, octenylsuccinate (OSAN) substituted waxy corn starches of various types such as 1) waxy starch: acid thinned and OSAN substituted, 2) blend of corn syrup solids: waxy starch, OSAN substituted, and dextrinized, 3) waxy starch: OSAN substituted and dextrinized, 4) blend of corn syrup solids or maltodextrins with waxy starch: acid thinned OSAN substituted, and then cooked and spray dried, 5) waxy starch: acid thinned and OSAN substituted then cooked and spray dried, and 6) the high and low viscosities of the above modifications (based on the level of acid treatment) can also be used in the present invention.

Modified starches having emulsifying and emulsion stabilizing capacity such as starch octenyl succinates have the ability to entrap the perfume oil droplets in the emulsion due to the hydrophobic character of the starch modifying agent. The perfume oils remain trapped in the modified starch until dissolved in use, due to thermodynamic factors i.e., hydrophobic interactions and stabilization of the emulsion because of steric hindrance.

Preferably, the perfume composition of the invention is encapsulated with modified starch to form the modified starch encapsulate. More preferably, the encapsulating material is water-soluble modified starch solid matrix, advantageously a starch raw material that has been modified by treating said starch raw material with octenyl-succinic acid anhydride. More preferably the said modified starch is mixed with a polyhydroxy compound before treatment with octenyl-succinic acid anhydride.

More preferably still, the modified starch is a waxy, maize starch, pregelatinised, dextrinised and is mixed with sorbitol or mono- or polyhydric alcohols, such as glycerin or propylene glycol, or sugar alcohols and then treated with octenyl succinic anhydride.

Suitable examples of said encapsulating materials are N-Lok™, manufactured by National Starch, Narlex™ (ST and ST2), and Capsul E™. These encapsulating materials comprise pregelatinised waxy maize starch and optionally, glucose. The starch is modified by adding monofunctional substituted groups such as octenyl succinic acid anhydride.

A further encapsulating material that may be used according to the invention is cyclodextrin. As used herein, the term “cyclodextrin” includes any of the known cyclodextrins such as unsubstituted cyclodextrins containing from six to twelve glucose units, especially, alpha-, beta-, gamma-cyclodextrins, and mixtures thereof, and/or their derivatives, and/or mixtures thereof, that are capable of forming inclusion complexes with perfume ingredients. Alpha-, beta-, and gamma-cyclodextrins can be obtained from, among others, American Maize-Products Company (Amaizo), Corn Processing Division, Hammond, Ind.; and Roquette Corporation, Gurnee, Ill. Many derivatives of cyclodextrins are known. Preferably, beta cyclodextrin is employed.

The ratio of fragrance to encapsulating material is typically in the range 5:1 to 1:10 and depends on the absorbency of the fragrance carrier. Typical ratio ranges are found in Table 3:

TABLE 3

| | Ratio of Fragrance to |
|---|---|
| Fragrance Carrier | Encapsulating Material |
| Silica | 2:1-1.1 |
| Zeolite | 1:6-1.14 |
| Starch | 1:2-1.4 |
| Cyclodextrin | 1:6-1.14 |

According to a second aspect of the invention, personal cleansing compositions, such as body washes, shampoos and soap bars, comprising perfume compositions, particularly encapsulated perfume compositions, according to the first aspect of the invention are provided. The present perfume compositions find particular application in soap bars.

The total amount of encapsulated perfume contained within the personal cleansing composition depends on the encapsulating material: in the case of silica, the personal cleansing composition may comprise from 0.01 to 10%, preferably from 0.25 to 5% and more preferably from 0.5 to 3% silica-encapsulated perfume; in the case of zeolite, the personal cleansing composition may comprise from 0.01 to 25%, preferably from 0.5 to 15% and more preferably from 1 to 10% zeolite-encapsulated perfume; in the case of starch, the personal cleansing composition may comprise from 0.01 to 10%, preferably from 0.25 to 5% and more preferably from 0.5 to 3% of starch-encapsulated perfume; in the case of beta cyclodextrin, the personal cleansing composition may comprise from 0.01 to 25%, preferably from 0.5 to 15% and more preferably from 1% to 10% beta cyclodextrin-encapsulated perfume.

Personal cleansing compositions, particularly soap bars, according to the invention comprise from about 20% to about 99.9%, preferably from about 30% to about 99%, more preferably from about 40% to about 90% of a surfactant, which may include soap, synthetic surfactant, or a combination of both.

As used herein, the term “soap” shall be understood to include the alkali metal salt or triethanolamine (TEA) salt of a carboxylic acid derived from animal fats or vegetable oils having a pH from 4 to 11. Typically, soap is based on mixtures of fatty acids obtained from tallow, coconut or palm oil.

Suitable synthetic surfactants include any surfactants known for use in personal cleansing compositions, such as anionic, nonionic, amphoteric and zwitterionic synthetic detergents. Both low and high lathering and high and low water-soluble surfactants can be used in the compositions of the present invention. Suds boosting synthetic detergent surfactants and/or synthetic detergent surfactants that are known as good dispersants for soap curds that are formed in hard water, are particularly desirable.

Non-limiting examples include the water-soluble salts of organic, sulfonic acids and of aliphatic sulfuric acid esters, preferably water-soluble salts of organic sulfuric reaction products having, in the molecular structure, an alkyl radical with 10 to 22 carbon atoms and a radical selected from the group consisting of sulfonic acid and sulfuric acid ester radicals.

Synthetic sulfate detergents of special interest are the normally solid alkali metal salts of sulfuric acid esters of normal primary aliphatic alcohols having from 10 to 22 carbon atoms. Thus, the sodium and potassium salts of alkyl sulfuric acids obtained from the mixed higher alcohols derived by the reduction of tallow or by the reduction of coconut oil, palm oil, palm kernel oil, palm oil stearin, babassu kernel oil or other oils of the lauric oil group can be used herein.

Other aliphatic sulfuric acid esters which may be employed include the water-soluble salts of sulfuric acid esters of polyhydric alcohols which have been incompletely esterified with high molecular weight soap-forming carboxylic acids. Such synthetic detergents include the water-soluble alkali metal salts of sulfuric acid esters of higher molecular weight fatty acid monoglycerides, such as the sodium and potassium salts of the coconut oil fatty acid monoester of 1,2-hydroxypropane-3-sulfuric acid ester, sodium and potassium monomyristoyl ethylene glycol sulfate, and sodium and potassium monolauroyl diglycerol sulfate.

Some examples of good mild, lather-enhancing, synthetic detergent surfactants are, sodium lauroyl sarcosinate, alkyl glyceryl ether sulfonate (AGS), sulfonated fatty esters, sulfonated fatty acids and sodium topped cocoyl isethionate (as described in U.S. Pat. No. 5,681,980).

Examples of other surfactants are alkyl sulfates, anionic acyl sarcosinates, methyl acyl taurates, N-acyl glutamates, acyl isethionates, alkyl sulfosuccinates, alkyl phosphate esters, ethoxylated alkyl phosphate esters, trideceth sulfates, protein condensates, mixtures of ethoxylated alkyl sulfates and alkyl amine oxides, betaines, sultaines, and mixtures thereof. Included in the surfactants are the alkyl ether sulfates with 1 to 12 ethoxy groups, especially ammonium and sodium lauryl ether sulfates.

Alkyl chains for these other surfactants may have from 8 to 22, preferably from 10 to 18, carbon atoms. Alkyl glycosides and methyl glucose esters are preferred mild nonionics which can be mixed with other mild anionic or amphoteric surfactants in the compositions of this invention. Alkyl polyglycoside detergents are useful lather enhancers.

In the event that the personal cleansing composition is a soap bar, then the present invention comprises three broad categories of bars:
(a) Those containing soap alone (ie no synthetic detergents)
(b) Those containing a ratio of soap to synthetic detergent of from 2:1 to 25:1. The choice of suitable ratios will depend upon the particular synthetic detergent, the desired performance and physical characteristics of the finished bar, temperature, moisture and like processing considerations. A preferred ratio is from about 3:1 to about 7:1.
(c) Those containing a ratio of synthetic detergent to soap of from about 1:1 to about 15:1. The choice of suitable ratios will depend upon the particular synthetic detergent, the desired performance and physical characteristics of the finished bar, temperature, moisture and like processing considerations. A preferred ratio is from about 2:1 to about 7:1.

The personal cleansing compositions, particularly soap bars, according to the present compositions may also comprise a base fragrance material, which is not encapsulated. As used herein the term “fragrance” is used to indicate any odouriferous material. Any fragrance material suitable for use in cosmetic compositions may be used herein but the fragrance will most often be liquid at ambient temperatures. Generally, the fragrance material will be present at a level of from about 0.01% to about 15%, by weight, of total composition. Preferably the fragrance material is present at a level of from about 0.05% to about 10%, more preferably from about 0.1% to about 5%, by weight, of total composition.

A wide variety of chemicals are known for fragrance uses, including materials such as aldehydes, ketones and esters. More commonly, naturally occurring plant and animal oils and exudates comprising complex mixtures of various chemical components are known for use as fragrances. The fragrances herein can be relatively simple in their compositions, comprising a single chemical, or can comprise highly sophisticated complex mixtures of natural and synthetic chemical components, all chosen to provide any desired odour.

Preferably the fragrance materials of the present invention will have boiling points (BP) of about 500° C. or lower, more preferably about 400° C. or lower, even more preferably about 350° C. or lower. The BP of many fragrance materials are given in Perfume and Flavor Chemicals (Aroma Chemicals), Steffen Arctander (1969). The ClogP value of the fragrance materials useful herein is preferably greater than about 0.1, more preferably greater than about 0.5, even more preferably greater than about 1.0, even more preferably still greater than about 1.2.

Suitable fragrance materials can be found in U.S. Pat. No. 4,145,184, U.S. Pat. No. 4,209,417, U.S. Pat. No. 4,515,705, and U.S. Pat. No. 4,152,272. Examples of fragrances useful herein include, but are not limited to, animal fragrances such as musk oil, civet, castoreum, ambergris, plant fragrances such as nutmeg extract, cardomon extract, ginger extract, cinnamon extract, patchouli oil, geranium oil, orange oil, mandarin oil, orange flower extract, cedarwood, vetyver, lavandin, ylang extract, tuberose extract, sandalwood oil, bergamot oil, rosemary oil, spearmint oil, peppermint oil, lemon oil, lavender oil, citronella oil, chamomille oil, clove oil, sage oil, neroli oil, labdanum oil, eucalyptus oil, verbena oil, mimosa extract, narcissus extract, carrot seed extract, jasmine extract, olibanum extract, rose extract and mixtures thereof.

Other examples of suitable fragrance materials include, but are not limited to, chemical substances such as acetophenone, adoxal, aldehyde C-12, aldehyde C-14, aldehyde C-18, allyl caprylate, allyl heptanoate, ambroxan, amyl acetate, dimethylindane derivatives, α-amylcinnamic aldehyde, anethole, anisaldehyde, benzaldehyde, benzyl acetate, benzyl alcohol and ester derivatives, benzyl propionate, benzyl salicylate, beta gamma hexanol, borneol, butyl acetate, camphor, carbitol, carvone, cetalox, cinnamaldehyde, cinnamyl acetate, cinnamyl alcohol, cis-3-hexanol and ester derivatives, cis-3-hexenyl methyl carbonate, cis jasmone, citral, citronnellol and ester derivatives, cumin aldehyde, cyclamen aldehyde, cyclo galbanate, damascones, decalactone, decanol, decyl aldehyde, estragole, delta muscenone, dihydromyrcenol, dimethyl benzyl carbinol, 6,8-dimethyl-2-nonanol, dimethyl benzyl carbinyl butyrate, ethyl acetate, ethyl isobutyrate, ethyl butyrate, ethyl 2 Methyl Butyrate, ethyl maltol, ethyl propionate, ethyl caprylate, ethyl cinnamate, ethyl hexanoate, ethyl valerate, ethyl vanillin, eugenol, exaltolide, fenchone, floralozone, fruity esters such as ethyl 2-methyl butyrate, galaxolide, gamma decalactone, geraniol and ester derivatives, hedione, helional, 2-heptonone, hexenol, hexyl acetate, hexyl salicylate, α-hexylcinnamic aldehyde, p-hydroxy phenyl butanone, hydroxycitrolnellal, indole, isoamyl acetate, isoeugenol acetate, ionones, isoeugenol, isoamyl iso-valerate, iso E super, limonene, linalool, linalool acteate, lilial, linalyl acetate, lyral, majantol, mayol, melonal, menthol, p-methylacetophenone, methyl anthranilate, methyl cedrylone, methyl dihydrojasmonate, methyl eugenol, methyl ionone, methyl-β-naphthyl ketone, methylphenylcarbinyl acetate, mugetanol, γ-nonalactone, 2-6 nonedienal, octanal, para hydroxy phenyl butanone, polysantol, phenoxynol, phenyl ethyl acetate, phenyl-acetaldehyde dimethyl acetate, phenoxyethyl isobutyrate, phenyl ethyl alcohol, pinenes, sandalore, sanjinol, santalol, stemone, thymol, terpenes, tonalide, triplal, triethyl citrate, 3,3,5-trimethylcyclohexanol, γ-undecalactone, undecavertol, undecenal, undecylenic aldehyde, vanillin, veloutone, verdox and mixtures thereof.

Personal cleansing compositions, particularly soap bars, according to the present invention may comprise from 1% to 85%, preferably from 1 to 40%, more preferably from 5% to 20%, water.

The personal cleansing compositions, especially soap bars, according to the present invention may also include other optional ingredients, such as polymeric skin mildness aids, fillers, sanitizing or antimicrobial agents, dyes, preservatives, compatible salts and salt hydrates and the like.

The personal cleansing compositions defined herein may be applied as a hot melt or spray dried onto non-woven articles.

### EXAMPLES

The following examples further describe and demonstrate the preferred embodiments within the scope of the present invention. The examples are given solely for the purpose of illustration, and are not to be construed as limitations of the present invention since many variations thereof are possible without departing from its scope.

| | | | | |
|---|---|---|---|---|
| | Conc | ODT | Boling Point | |
| HIA Perfume Ingredient name | (% w/w) | (ppb) | (° C.) | ClogP |

Example 1

| | | | | |
|---|---|---|---|---|
| Benzaldehyde | 3.5 | ≦50 | 177 | 1.5 |
| Gamma undecalactone | 17.3 | ≧50 | 260 | 3.8 |
| Ionone Beta | 8.00 | ≦50 | 276 | 3.8 |
| Allyl Heptanoate | 8.00 | ≧50 | 212 | 3.4 |
| Natural Sinensal | 3.50 | ≦50 | 295 | 4.5 |
| Mandarin Aldehyde | 3.50 | ≦50 | 261 | 4.6 |
| Oxane | 2.30 | ≦50 | 206 | 2.4 |
| Beta Gamma Hexenol | 0.60 | ≧50 | 159 | 1.4 |
| Cis 3 Hexenyl Acetate | 1.00 | ≧50 | 179 | 2.3 |
| Verdox | 21.20 | ≧50 | 237 | 4.1 |
| Decyl Aldehyde | 6.1 | ≦50 | 218 | 4 |
| Methyl-2-nonenoate | 2.00 | ≦50 | 211 | 3.97 |
| Hexyl Cinnamic Aldehyde | 11.50 | ≧50 | 334 | 4.9 |
| d-limonene | 11.50 | ≧50 | 170 | 4.4 |

Example 2

| | | | | |
|---|---|---|---|---|
| 2-6-nonadienal | 0.5 | ≦50 | 210 | 2.7 |
| Adoxal | 0.5 | ≧50 | 276 | 5.2 |
| Allyl Heptanoate | 5.5 | ≧50 | 212 | 3.4 |
| Beta Gamma Hexenol | 1.0 | ≧50 | 159 | 1.4 |
| Cis 3 Hexenyl Acetate | 2.25 | ≧50 | 179 | 2.3 |
| Citralva Plus | 1.0 | ≦50 | 249 | 3.3 |
| d-limonene | 11.3 | ≧50 | 170 | 4.4 |
| Damarose Alpha | 0.5 | ≦50 | 257 | 3.6 |
| Decyl Aldehyde | 2.25 | ≦50 | 218 | 4.0 |
| Hexyl Cinnamic Aldehyde | 9.0 | ≧50 | 334 | 4.9 |
| Mandarin Aldehyde | 3.5 | ≦50 | 261 | 4.6 |
| ethyl-2-methyl butyrate | 3.5 | ≦50 | 132 | 2.1 |
| Melonal | 1.2 | ≦50 | 188 | 2.6 |
| Methyl Nonyl Acetaldehyde | 1.0 | ≦50 | 237 | 4.9 |
| Natural Sinensal | 3.5 | ≦50 | 295 | 4.5 |
| Nectaryl | 9.0 | ≧50 | 317 | 4.4 |
| Neobutenone | 0.5 | ≦50 | 233 | 3.63 |
| decyl aldehyde | 9.0 | ≦50 | 218 | 4 |
| Para Hydroxy | 1.5 | ≦50 | 301 | 1.1 |
| Phenyl Butanone | | | | |
| Pino Acetaldehyde | 3.5 | ≦50 | 257 | 3.3 |
| Trans-2 Hexenal | 0.5 | ≦50 | 145 | 1.6 |
| Undecalactone | 9.0 | ≧50 | 260 | 3.8 |
| methyl-2-nonenoate | 3.5 | ≦50 | 211 | 3.97 |
| Verdox | 11.5 | ≧50 | 237 | 4.1 |
| Ionone Beta | 5.5 | ≦50 | 276 | 3.8 |

### MANUFACTURE OF ENCAPSULATED PERFUMES

The perfume compositions defined above were encapsulated as per the following non-limiting examples of suitable processes for manufacture of a encapsulated perfume compositions.

Starch—Perfume Encapsulation
(1) 225 g of CAPSUL modified starch (National Starch & chemical) is added to 450 g of water at 24° C.
(2) The mixture if agitated at 600 rpm (turbine impellar 2 inches in diameter) for 20 minutes
(3) 75 g of perfume composition is added near the vortex of the starch solution
(4) The emulsion formed is agitated for an additional 20 minutes (at 600 rpm)
(5) Upon achieving a perfume droplet size of less than 15 microns, the emulsion is pumped to a spray drying tower and atomised through a spinning disk with co-current airflow for drying. The inlet air temperature is set at 205-210° C., the exit air temperature is stabilised at 98-103° C.
(6) Dried particles of the starch encapsulated perfume composition are collected at the dryer outlet

Analysis of the finished HIA perfume particle (all % based on weight)

| | |
|---|---|
| Total Oil | 49.0% |
| Encapsulated oil | 48.0% |
| Free/Surface oil | 1.0% |
| Starch | 48.25% |
| Moisture | 1.5% |

Beta Cyclodextrin—Perfume Encapsulation

Weigh water into a beaker and add Beta Cyclodextrin (BCD) in a 1:1 ratio. Mix using an overhead stirrer. Slowly add perfume to the BCD/water mixture (BCD/water: Perfume ratio is approx. 10:1), mixing with an overhead stirrer until the mixture begins to thicken. When the mixture has thickened add more water to thin down the mixture. Continue stirring with the overhead mixer until the mixture thickens up once again, then spread the mixture out onto flat trays, creating thin films. Allow to dry overnight at room temperature. When dry, mill or ground into a fine powder before use.

Silica—Perfume Encapsulation

A Silica-Perfume encapsulate is prepared by slowly adding perfume into Silica powder in a kitchen blender and thoroughly mixing until a free flowing powder, with no free oil is obtained.

Zeolite—Perfume Encapsulation

A Zeolite-Perfume encapsulate is prepared by slowly adding perfume into Zeolite and mixing with an overhead mixer for 2 hours

### MANUFACTURE OF BAR SOAPS (RELEVANT TO EXAMPLES 3,4,5)

Mix base fragrance & encapsulated fragrance into dried soap noodles in an amalgamator. The material is processed, for example by milling through a 3-roll soap mill, to obtain a homogeneous mixture of perfume & soap flakes. Then the material is processed on a plodder and is stamped into a soap bar.

In the personal cleansing compositions that follow, the abbreviated component identifications have the following meanings:
HIA1 SEA: Starch encapsulated (SEA means “starch encapsulated accord”) HIA perfume particle from perfume composition Example 1, wherein the starch is a CAPSUL modified starch (National Starch & Chemicals), known by the name of TUK2001 & TUK2002.

HIA2 SEA: Starch encapsulated HIA perfume particle from perfume composition Example 2, wherein the starch is a CAPSUL modified starch (National Starch & Chemicals), known by the name of TUK2001 & TUK2002.

HIA1 BCD: beta cyclodextrin (BCD) HIA perfume particle from perfume composition Example 1, wherein the BCD used is Cerestar from Cargill, Cargill Cerestar BVBA Office Park Mechelen, Bedrijvenlaan 9,2800 Mechelen, Belgium or where the BCD is Cavamax W7 is from Wacker Biochem Corporation, 3301 Sutton Road, Adrian, Mich. 49221-9397,USA.

HIA2 BCD: beta cyclodextrin HIA perfume particle from perfume composition Example 2, wherein the BCD used is Cerestar from Cargill, Cargill Cerestar BVBA Office Park Mechelen, Bedrijvenlaan 9,2800 Mechelen, Belgium or where the BCD is Cavamax W7 is from Wacker Biochem Corporation, 3301 Sutton Road, Adrian, Mich. 49221-9397,USA.

HIA1 Silica: silica HIA perfume particle from perfume composition Example 1, wherein the silica used is Syloid R244, from W. R. Grace & Co., Davison Chemical Division, P.O. Box 2117, Baltimore, Md. 21203.

HIA2 Silica: silica HIA perfume particle from perfume composition Example 2, wherein the silica used is Syloid R244, from W. R. Grace & Co., Davison Chemical Division, P.O. Box 2117, Baltimore, Md. 21203.

HIA1 Zeolite: zeolite HIA perfume particle from perfume composition Example 1, wherein the zeolite used is Zeolite 13X or 13Y, from W. R. Grace & Co., Davison Chemical Division, P.O. Box 2117, Baltimore, Md. 21203.

HIA2 Zeolite: zeolite HIA perfume particle from Perfume composition Example 2, wherein the zeolite used is Zeolite 13X or 13Y, from W. R. Grace & Co., Davison Chemical Division, P.O. Box 2117, Baltimore, Md. 21203.

### Example 3

Personal Cleansing Bar Soap Composition comprising encapsulated perfume;

| | A | B | C | D | E | F | G | H |
|---|---|---|---|---|---|---|---|---|
| Ingredient | % w/w | % w/w | % w/w | % w/w | % w/w | % w/w | % w/w | % w/w |
| Soap | 80.15 | 77.95 | 80.15 | 72.65 | 80.15 | 77.25 | 80.15 | 72.65 |
| Free Fatty Acid | 5.73 | 5.70 | 5.00 | 3.1 | 5.83 | 5.90 | 5.00 | 3.1 |
| Water | 11.56 | 11.50 | 10.69 | 11.9 | 11.56 | 11.50 | 10.69 | 11.9 |
| Sodium Chloride | 1.11 | 1.10 | 1.11 | 1.10 | 1.11 | 1.10 | 1.11 | 1.10 |
| Titanium | 0.25 | 0.25 | 0.25 | 0.25 | 0.25 | 0.25 | 0.25 | 0.25 |
| Dioxide | | | | | | | | |
| Perfume | 0.80 | 1.00 | 0.80 | 1.00 | 0.80 | 1.00 | 0.80 | 1.00 |
| HIA1 SEA | 0.40 | — | — | — | — | — | — | — |
| HIA2 SEA | — | 2.5 | — | — | — | — | — | — |
| HIA1 BCD | — | — | 2.0 | — | — | — | — | — |
| HIA2 BCD | — | — | — | 10.0 | — | — | — | — |
| HIA1 Silica | — | — | — | — | 0.30 | — | — | — |
| HIA2 Silica | — | — | — | — | — | 3.0 | — | — |
| HIA1 Zeolite | — | — | — | — | — | — | 2.0 | — |
| HIA2 Zeolite | — | — | — | — | — | — | — | 10.0 |

### Example 4

Personal Cleansing Bar Soap Composition comprising encapsulated perfume;

| | A | B | C | D | E | F | G | H |
|---|---|---|---|---|---|---|---|---|
| Ingredient | % w/w | % w/w | % w/w | % w/w | % w/w | % w/w | % w/w | % w/w |
| Soap | 64.46 | 65.2 | 63.26 | 55.75 | 65.3 | 63.25 | 4.29 | 3.25 |
| Free Fatty Acid | 4.69 | 3.25 | 4.29 | 3.9 | 3.25 | 5.2 | 10.0 | 8.5 |
| Potassium Alkyl | 10.0 | 8.5 | 10.0 | 7.75 | 8.5 | 7.75 | 3.0 | 4.5 |
| Sulfate | | | | | | | | |
| Sodium Laureth 3 | 3.0 | 4.5 | 3.0 | 3.5 | 4.5 | 3.5 | 7.5 | 7.0 |
| Sulfate | | | | | | | | |
| Water | 7.5 | 7.0 | 7.5 | 9.75 | 7.0 | 7.75 | 0.90 | 0.90 |
| Sodium Chloride | 0.90 | 0.90 | 0.90 | 0.90 | 0.90 | 0.90 | 0.25 | 0.25 |
| Titanium Dioxide | 0.25 | 0.25 | 0.25 | 0.25 | 0.25 | 0.25 | 7.5 | 7.5 |
| Magnesium | 7.5 | 7.5 | 7.5 | 7.5 | 7.5 | 7.5 | 0.5 | 0.5 |
| Silicate | | | | | | | | |
| Misc | 0.5 | 0.5 | 0.5 | 0.3 | 0.5 | 0.5 | 0.80 | 1.50 |
| Perfume | 0.80 | 1.50 | 0.80 | 0.4 | 1.50 | 0.4 | — | — |
| HIA1 SEA | 0.40 | — | — | — | — | — | — | — |
| HIA2 SEA | — | 0.9 | — | — | — | — | — | — |
| HIA1 BCD | — | — | 2.0 | — | — | — | — | — |
| HIA2 BCD | — | — | — | 10.0 | — | — | — | — |
| HIA1 Silica | — | — | — | — | 1.0 | — | — | — |
| HIA2 Silica | — | — | — | — | — | 3.0 | — | — |
| HIA1 Zeolite | — | — | — | — | — | — | 2.0 | — |
| HIA2 Zeolite | — | — | — | — | — | — | — | 5.0 |

Magnesium silicate is ORIENTAL MICRO/STEASILK, LUZENAC AMERICA, HOUSTON, USA
Sodium Laureth 3 Sulfate is STEOL SLE3S, STEPAN MEXICO, MATAMOROS, TAMPS, LA
Potassium Alkyl Sulfate is SULFOPON K, COGNIS MEXICO
Misc. represents miscellaneous unreacted feedstocks & products of secondary side reactions.

### Example 5

Personal Cleansing Bar Soap Composition comprising encapsulated perfume

| | A | B | C | D | E | F | G | H |
|---|---|---|---|---|---|---|---|---|
| Ingredient | % w/w | % w/w | % w/w | % w/w | % w/w | % w/w | % w/w | % w/w |
| Sodium Cocoyl | 21.7 | 22.5 | 21.7 | 16.5 | 21.7 | 22.0 | 21.7 | 20.0 |
| Isethionate | | | | | | | | |
| (STCI) | | | | | | | | |
| Paraffin | 18.9 | 19.4 | 18.9 | 17.2 | 18.9 | 19.4 | 18.9 | 18.2 |
| Sodium Alkyl | 18 | 17.2 | 16.5 | 15.6 | 18 | 17.2 | 16.5 | 15.6 |
| Glyceryl Ether | | | | | | | | |
| Sulfonate | | | | | | | | |
| Sodium | 3.0 | 3.0 | 3.0 | 1.5 | 3.0 | 3.0 | 3.0 | 1.5 |
| Isethionate | | | | | | | | |
| PEG 90M | 0.05 | 0.05 | 0.05 | 0.05 | 0.05 | 0.05 | 0.05 | 0.05 |
| Sodium Soap | 4 | 4 | 4 | 4 | 4 | 4 | 4 | 4 |
| Magnesium | 6.5 | 6.5 | 6.5 | 6.5 | 6.5 | 6.5 | 6.5 | 6.5 |
| Soap | | | | | | | | |
| Fatty Acid | 9 | 9 | 7.5 | 9 | 9 | 9 | 7.5 | 9 |
| Titanium | 0.25 | 0.25 | 0.25 | 0.25 | 0.25 | 0.25 | 0.25 | 0.25 |
| Dioxide | | | | | | | | |
| Water | 5.0 | 5.0 | 6.0 | 7.5 | 4.9 | 5.0 | 6.0 | 7.5 |
| Miscellaneous | 9.0 | 9.0 | 6.9 | 9.0 | 9.0 | 9.0 | 6.9 | 9.0 |
| Perfume | 1.50 | 0.4 | 1.50 | 0.4 | 1.50 | 0.4 | 1.50 | 0.4 |
| HIA1 SEA | — | 2.5 | — | — | — | — | — | — |
| HIA2 SEA | 0.9 | — | — | — | — | — | — | — |
| HIA1 BCD | — | — | 5.0 | — | — | — | — | — |
| HIA2 BCD | — | — | — | 12.5 | — | — | — | — |
| HIA1 Silica | — | — | — | — | — | 3.0 | — | — |
| HIA2 Silica | — | — | — | — | 1.0 | — | 5.0 | — |
| HIA1 Zeolite | — | — | — | — | — | — | — | 8.0 |
| HIA2 Zeolite | — | — | — | — | — | — | 0.05 | 0.05 |

Sodium Cocoyl Isethionate (STCI) is HOSTAPON IPF M-4, CLARIANT-MT HOLLY, USA
Paraffin is PARVAN 138, EXXON CO. BATON RIDGE, USA
Sodium Alkyl Glyceryl Ether Sulfonate is AGS, P&G CHEMICALS COMPANY, KANSAS CITY
Sodium Isethionate is HOSTAPON SI, CLARIANT-MT HOLLY, USA
PEG90M is POLYOX WSR-301, UNION CARBIDE, AMERCHOL
TITANIUM DIOXIDE is TITANIUM DIOXIDE 20-71-U, KRONOS CANADA INC, VARANNES, CANADA

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A perfume composition comprising:
a) at least 10% by weight of at least one High Impact Accord (“HIA”) perfume ingredient of Class 1, wherein Class 1 perfume ingredients have (1) a boiling point at about 760 mm Hg, of 275° C. or lower, (2) a calculated CLogP of at least about 2.0, and (3) an odor detection threshold (“ODT”) less than or equal to about 50 ppb; and
b) from about 0.01 to less than about 30% by weight of at least one High Impact Accord (“HIA”) perfume ingredient of Class 2, wherein Class 2 perfume ingredients have (1) a boiling point at about 760 mm Hg, of greater than about 275° C., (2) a calculated CLogP of at least about 4.0, and (3) an odor detection threshold (“ODT”) less than or equal to about 50 ppb.

2. The composition according to claim 1, comprising from about 15 to about 75%, preferably from about 15 to about 50% by weight HIAs from Class 1.

3. The composition according to claim 1, comprising from about 0.01 to about 25% by weight HIAs from Class 2.

4. The composition according to claim 1, wherein the perfume is encapsulated in an encapsulation material.

5. The composition according to claim 1, wherein the encapsulation material comprises starch, cyclodextrin, zeolite, silica or mixtures of these materials.

6. A composition according to claim 5, wherein the material used for encapsulating the perfume material is a water-soluble modified starch solid matrix, preferably a starch raw material that has been modified by treating said starch raw material with octenyl-succinic acid anhydride.

7. A composition according to claim 6, wherein said modified starch is mixed with a polyhydroxy compound before treatment with octenyl-succinic acid anhydride.

8. A personal cleansing composition, especially a bar soap, comprising a surfactant and a perfume composition according to claim 1.

9. A personal cleansing composition, especially a bar soap, comprising from about 0.01 to about 10% by weight of encapsulated perfume according to claim 6.
